(19) United States
(12) Patent Application Publication
(10) Pub. No.: US 2011/0106579 A1
(43) Pub. Date: May 5, 2011

(54) System and Method of Management and Reduction of Subscriber Churn in Telecommunications Networks

(75) Inventors: Biju Nair, Long Grove, IL (US); Sumeet S. Paul, Chicago, IL (US); Sanida D. Bratt, Chicago, IL (US)

(73) Assignee: SAPIENCE TECHNOLOGY, INC., Long Grove, IL (US)

(21) Appl. No.: 12/908,922

(22) Filed: Oct. 21, 2010

Related U.S. Application Data
(60) Provisional application No. 61/257,998, filed on Nov. 4, 2009.

(51) Int. Cl. G06Q 10/00

(52) U.S. Cl. 705/7.28

(57) ABSTRACT

A closed loop system to monitor a communications system and to detect conditions indicative of deficient subscriber service. Circuitry responsive to the detected conditions to adjust one or more parameters of the communications system to improve subscriber service. Additional circuitry to provide subscriber feedback so as to try to minimize subscriber churn and reduce dissatisfaction.

### CROSS-REFERENCE TO RELATED APPLICATION

This application claims the benefit of the filing date of U.S. Provisional Application Ser. No. 61/257,998 filed Nov. 4, 2009 and entitled “Closed Loop Monitoring, Control and Feedback System for Management and Reduction of Subscriber Churn in Telecom Networks”. The '998 application is hereby incorporated herein by reference.

### FIELD

The invention pertains to systems and methods for managing and reducing subscriber churn in telecom networks. More particularly, the invention pertains to such systems and methods which monitor network operations on the network infrastructure end as well as usage patterns on client devices and, combine information obtained therefrom with other network related elements to automatically and in real-time provide feedback signals to network elements to:

(a) Proactively detect a problem

(b) Correct a detected problem and/or

(c) Predict the probability of an event happening

### BACKGROUND

Customer churn is defined as a phenomenon through which a business loses its inherent customers to competition due to a variety of reasons but primarily due to customer dissatisfaction. Customer churn is a pesky problem that continues to haunt every industry.

In case of certain vertical markets, such as telecommunications, customer churn has a particularly jarring effect on the economics of the company, such as a wireless operator, that incurs churn primarily due to the fact that the cost associated with acquiring the customer is fairly large. Furthermore, such costs are incurred by the companies up-front and prior to acquiring the customer with the hope of recouping that cost over a period of time by retaining that customer. Such costs include, but are not limited to, advertising, marketing costs & materials, subsidies offered to customers, and distributor discounts, etc.

Companies have come up with many “artificial” schemes to combat churn. Some such schemes include the companies putting the onus on the customer ensuring the return on their investment by locking the customers into a mandatory “term” contract. Customers incur financial penalties for breaching the contract. This is viewed by customers as being locked into a contract without any obligation by the company that offers the service or product to meet a certain grade of service. In many states and even other countries, courts are looking favorably towards the consumers in cases where they have chosen to go down the legal path to terminate their contracts without incurring those costs.

Existing systems are capable of collecting analytical data and monitoring networks through collection of an immense amount of data. However, known systems are focused on the physical transformation of such vast quantities of available data and transforming this data into information that is relevant to the operators of the system.

### BRIEF DESCRIPTION OF THE DRAWINGS

FIG. 1 is a block diagram of a telecommunication system which embodies the invention;

FIG. 2 is another block diagram which illustrates additional aspects of the system of FIG. 1;

FIG. 3 is a diagram of an exemplary Selection Criteria Engine;

FIG. 4 is a flow diagram of exemplary Exception Data Analysis processing;

FIG. 5 is a flow diagram of exemplary processing directing a subscriber to a better pricing plan;

FIG. 6 is a diagram of exemplary processing of demographics data; and

FIG. 7 is a diagram of exemplary processing responsive to an absent device.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention enable individuals or firms offering services and products to have a real time or very timely view of how their service or product is being received and perceived by the customer as well as continuous real time monitoring of the environment in the vertical space. The combined and timely information when monitored and modeled appropriately will not only offer a realistic view of how the customers are feeling about the company's offering, but will also enable predictive modeling that will facilitate better business planning and allow the firms to stay ahead of the churn curve.

Embodiments of the invention focus on transforming the existing data gathered from sources such as Mobile Analytics, Network Operations Center (Switches, Operations Systems Support (OSS), CRM, Billing, Client Devices, etc into usable information. Such information is then combined with information available from external inputs, such as marketing data and social media content, to create an efficient and self-regulating feedback loop into the network thereby enabling the network elements to correct themselves to potentially eliminate the anomaly in the network. Unlike systems available on the market, this provides mobile operator with an external as well as internal view of their service offering.

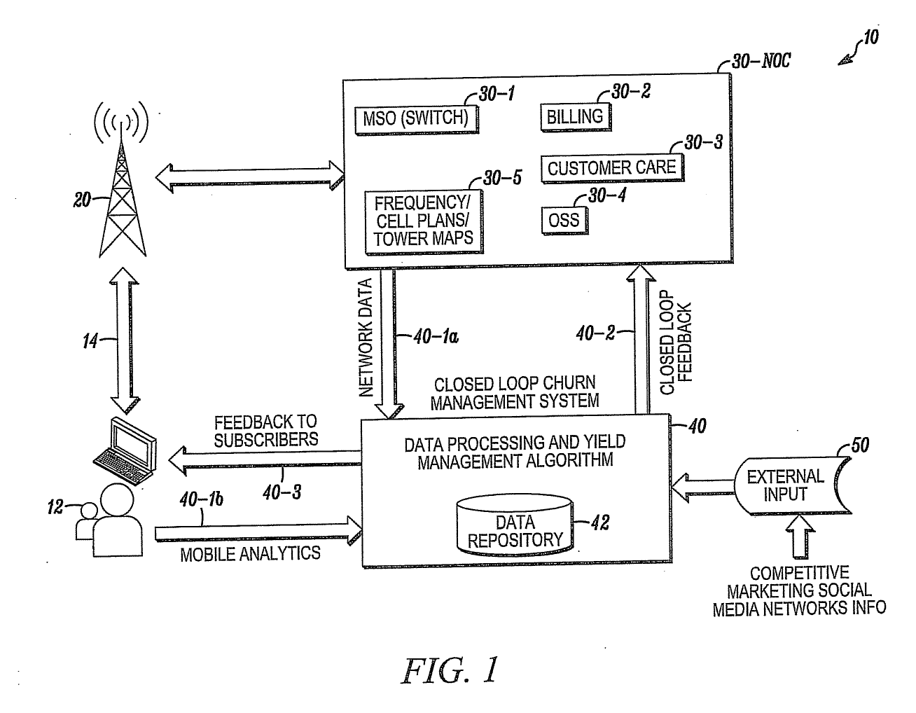

FIG. 1 illustrates an apparatus 10 which includes a wireless communications system 20, having a network operations center (NOC) 30, coupled to a closed loop churn management system 40. Subscribers 12 shown in the figure use mobile devices 14 available to them throughout the network 20. Network operations center 30 includes various systems that monitor and store data from performance of the network 20.

The mobile switching office (MSO) 30-1 of the service provider's network 20 typically contains the Call Detailed Records associated with all voice and data sessions of every subscriber. Other functions include billing 30-2, customer care 30-3, operations systems support 30-4, and frequency/call plans/tower maps 30-5.

The closed loop churn management system 40 described herein receives data 40-1a from various parts of the network 20, and customer end devices, 40-1b and transforms that data into relevant information using data processing and filtering techniques to isolate problem records. System 40 carries out processing based on pre-stored methods and attempts to provide solutions to the detected anomalies. The solution thus generated is transformed back into the NOC formats and fed back 40-2 to the element 30 with the intention of correcting the problem. Element 40 of the system also reaches out to, and communicates with, the subscriber 40-3 automatically to acknowledge the issues they are facing and suggest solutions.

With use of externally available information 50 such as competitive offerings, the system can also automatically inform the subscriber of the operators own offerings thereby pre-emptively directing the subscriber to its own offerings. Companies can also adjust their offerings based on “public opinion” or “social value”. Such opinions/values can be automatically gathered by monitoring relevant and popular social media networks and outlets, and such feedback considered in the system 40.

The closed loop system 40 feeds back digital signals, corrected network parameters or, recommendations 40-2 to element 30 of communication system 20 to fix operational or engineering issues. For example, based on empirical data, if the system notices consistent dropped calls at a certain location, it can refer to the existing frequency or cell plan as well as tower locations 30-5 to determine the required course of action such as down tilt of an antenna, etc. and feed that required action to the cellular regulation system to automatically change the tilt of that antenna to minimize or eliminate this problem. Other types of problems can be detected and network state or parameters can be altered in response thereto.

Thus signals 40-2 from system 40 can alter parameters of the wireless system 20. In addition to altering antenna positions, the signals 40-2 can alter gain values of circuitry in system 20, as well as other physical or electrical parameters without limitation.

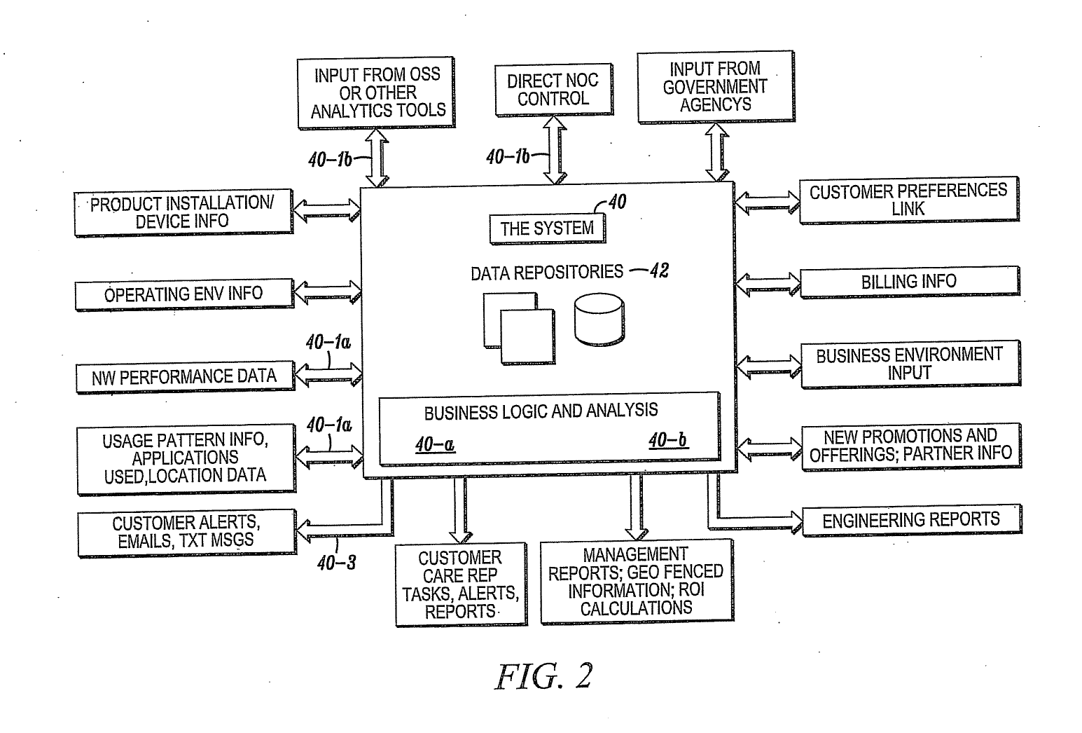

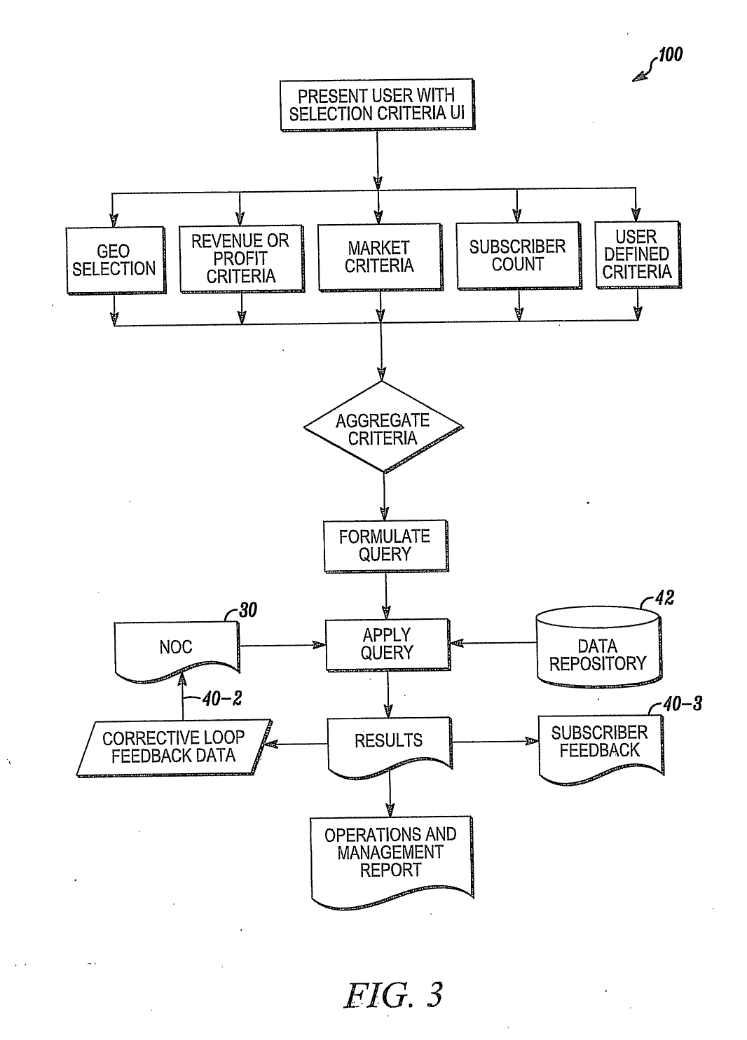

FIG. 2 illustrates aspects of the system 40. The system 40 includes a central repository of data 42 that gathers information about various aspects of the product and service offering, subscriber information, business environment information, billing information, user behavior pattern information, links into subscriber social networking, and other valuable information that can be used to enhance the product and service offering.

Processing by the system 40 can be implemented by circuitry 40a including a programmable processor which can execute instructions 40b stored on a computer readable medium.

Customer churn is a direct result of customer dissatisfaction with the product (such as a cellular phone or data device) or service offering. In order to reduce churn, embodiments of our invention monitor the service grade offered by the product and service using a customer life cycle approach.

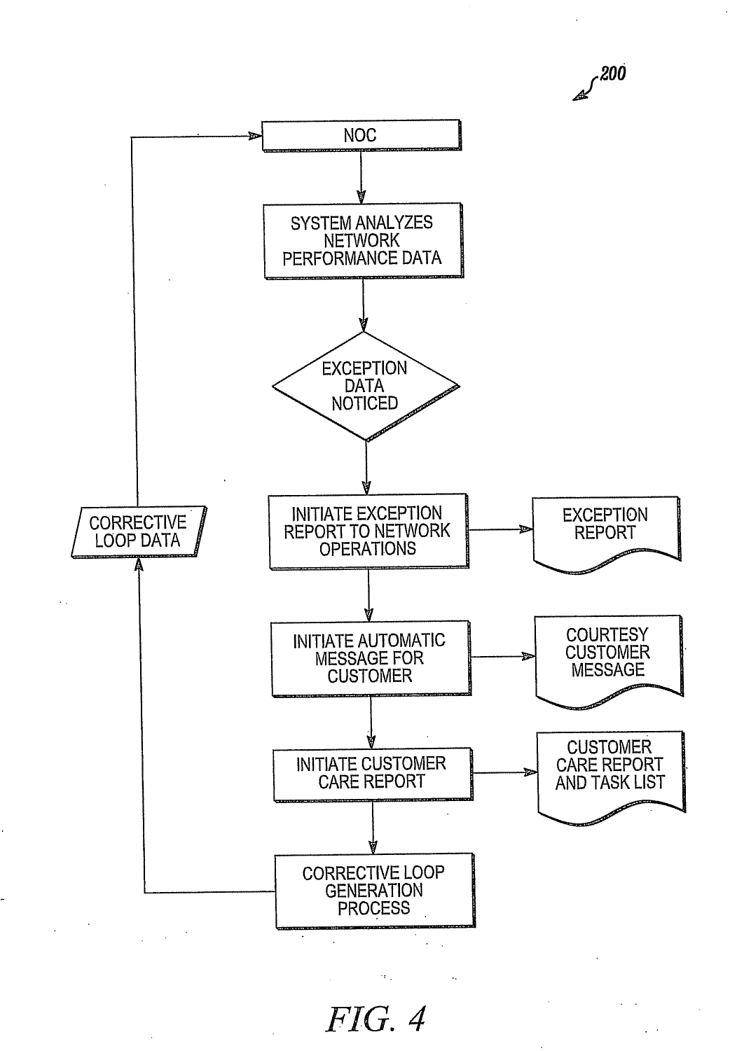

FIG. 3 illustrates exemplary processing 100 carried out by the system 40, which would result in a reduced set of data for processing. FIG. 4 illustrates other processing 200 carried out by the system 40, resulting in proactive outreach to subscribers in the event of a poor service experience.

When a customer receives a product for stand-alone usage or a product to be used in conjunction with a service offering, embodiments of the system will start to monitor the customer experience from the moment the consumer starts installation of the product. An extremely high percentage of product failures and product related customer dissatisfaction occur immediately upon initial use of the product, commonly referred to as “out of the box experience”. These include but are not limited to issues related to installation of the product.

Information about product installation failure is fed back into the system 40, with a priority tag. This enables the customer care representative to be aware of the failure and call the customer proactively and attempt to rectify the problem before the customer becomes dissatisfied. Due to this proactive approach, not only would the customer receive a better grade of service but also the firm's customer care representatives would have preemptively eliminated a potential customer churn.

Superior customer service also entails recognizing an inadvertent product failure and proactively placating the subscriber through an immediate promotion/discount on further usage of service or product purchase. This just-in-time reaction from a product or service organization has a pleasing response from the customer thereby creating not only good will but also a large measure of loyalty and customer advocacy of the product and its maker.

The failure information thus gathered is also fed into the company's product development organization to be handled as priority customer satisfaction issue and addressed in future product releases. Current information about the device and the Operating System (OS), keeps the usage information about the product and service current in the firm's operating processes. This information enables the firm to offer the most current updates and information to the subscriber base, as well as offer guidance to other parties in the cosystem with feedback required for improving their product offerings.

Since the product, such as device 14, is an integral piece of the service offering, the capabilities of the product will be used to gather information about the network's overall health and performance. The service experience perceived by the user is typically what causes dissatisfaction. Understanding these key issues and addressing them in a timely, proactive fashion can contribute substantially to eliminating churn.

Embodiments of the invention provide specific methods that will be deployed to ensure better customer experience. As an example, if a subscriber happens to experience difficulties while using the product and associated service (say a dropped call or slower data rates); such information is immediately available to the system. In response thereto, a minimally invasive message can be generated, such as an email or an SMS to the subscriber with an apology and/or with corrective remedies to rectify the situation.

Preferably, the system 40 is also connected to the carrier network operations center and to governmental law enforcement and first response systems.

Customer usage pattern, such as frequent networks connected to, frequent applications used, minutes of usage, quantity of data used, roaming information, alternative network availability etc. will be gathered by the system and processed to deduce information about the subscribers' preferences. The subscriber(s) can then be alerted to more preferred, available, methods to access and use the service in the future.

Location information can be used to further enhance the user experience by virtue of information available to the system including potential access to other types of networks. Information about other network types can be stored in the system with cross reference information with the location information.

Subscribers' current billing information can be retrieved from the billing system and will be periodically checked against the usage pattern to ensure that the customer is indeed receiving the best possible billing rate available to them. This data and information are very useful in churn reduction, as service cost and billing are two of the most cited reasons for churn. This information can be used by embodiments of the system to monitor situations where the user is close to exceeding predetermine thresholds of usage and determine efficient ways for the subscriber to continue usage of the service.

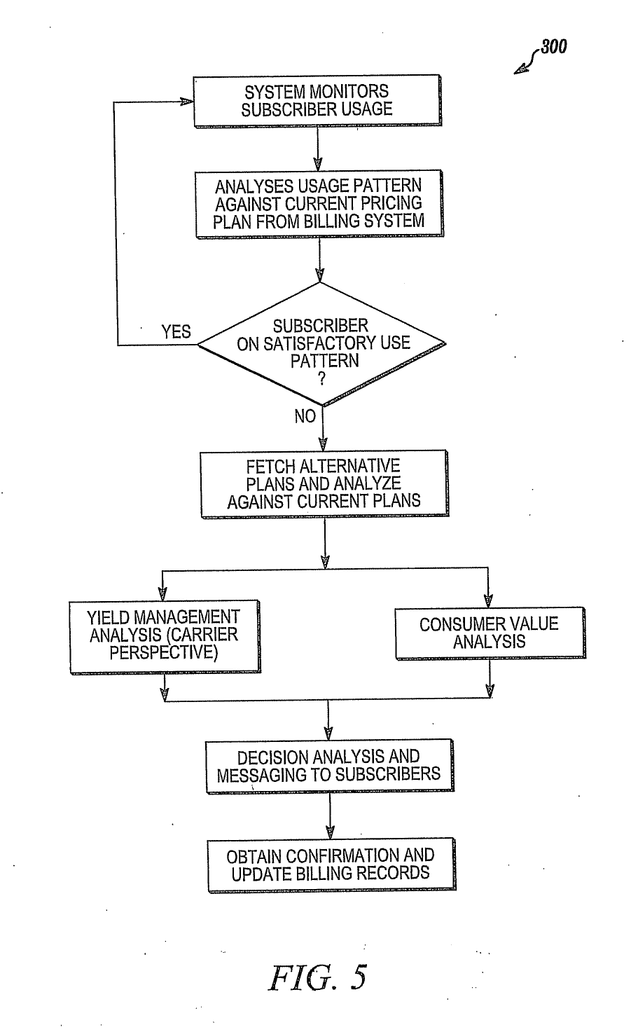

FIG. 5 illustrates processing 300 by the system 40 to direct a subscriber to a more favorable pricing plan. Processing 300 is unlike that of traditional systems which simply charge the subscriber on a premium rate of per minute or per Megabit charge. This is a no-win situation for the carrier and the subscribers because at the end of the billing cycle the customers are surprised and irate about the additional charges and regret the fact that they did not get an opportunity to buy the next level of usage. In preferred embodiments, the method described will monitor the usage pattern and at the appropriate time offer up the “best” possible usage rate. E.g.: Instead of continuing usage on a per minute or per data unit basis the customer can purchase an economical bucket of usage. This creates a wholesale purchase effect whereby both the service provider and the subscriber are satisfied due to the fact that the service provider made a bigger sale and the subscriber lowered their average cost as illustrated as in FIG. 5.

Embodiments of the present invention can focus on those subscribers who are most relevant to an organization, such as the ones that drive the most profit for the organization, or those who drive key marketing aspects (VIPs), geographical groups, or key billing demographics. Such selection criteria enables the system with its efficiency of transformation of huge quantities of raw data into useful information that can be automatically and quickly processed to improve the network performance through, either the automated closed loop feedback system or manual trouble tickets generated for network maintenance engineers.

In embodiments of the invention subscribers can be automatically alerted to new promotions or pricing that they can take advantage of along with the terms and conditions that apply to that promotion. Once again, under currently available methods, and unlike the present invention, subscribers are expected to take the initiative to call the carriers to avail of the pricing promotions. As a result most subscribers lose out on the promotion and end up disappointed. The present automated method will notify the subscriber, enable them to automatically accept the new plan through a push of the button on their device or software, accept or decline the pricing plan, and update the billing system automatically.

Where more stringent legal requirements are enforced for contract changes the push of a button on the user's device will connect them to the account representative who can adjust their billing contracts, and obtain the necessary legal acceptances. Using the present system, the account representative can direct them to the closest physical location after choosing a new plan where they can provide a written signature to their change in terms.

The carrier, utilizing embodiments of the invention, can thus focus its initial efforts on those specific customers, through the use of billing system data, network analytics from OSS systems, capacity information, and the real time view of end user difficulties, who are most critical to the overall business health. Additionally by using the other extreme end of the data provided carriers can target specific customers, whom they would like to churn off their networks and specifically not target those users for improved assistance, thereby targeting their resources towards the most cost effective locations. The same principals can also be utilized to employ targeted trials of this churn reduction system by geographical market, user demographic, device groups, type of account, etc.

In embodiments of the invention usage of business environment data in combination with location information enable a service provider to obtain better yield management. Network resources, their availability, bandwidth, as well as capacity in the network are all commodities that are subject to the normal economic aspects of supply and demand. The availability of such critical information will enable the business logic analysis component of the system to evaluate supply vs. demand and appropriately price the available network. For example, if 75000 people are at a stadium and the capacity and bandwidth consumption at such a location is increasing the embodiments of the present invention can adjust the pricing on the fly to allow the service provider to capitalize on this demand and enable them to charge certain non premier subscriber groups premium rates for access or to actively deny some customers in favor of other customers (rather than using today's first come first serve approach). It is envisioned that certain embodiments of the invention will use traditional metrics, such as Customer Lifetime Value (CLV) to calculate the “cost of churn”.

In yet another aspect of the invention, the system can also utilize information fed in from the NOC and government agencies to dynamically reallocate resources away from paying customers and towards emergency situations, similar to streetlights which have detectors for moving emergency vehicles and energizable visual signals. When an emergency situation arises the NOC or the responding agency, if they are connected, can trigger the same system to proactively alert the carrier to redirect both personnel and technical resources to support the emergency rather than servicing existing non-emergency customers. For example in the same stadium mentioned above, when a person has a heart attack and the EMTs arrive on scene, their specific devices will be given preferred status and the non-emergency customers will be actively removed/denied access to network resources while they are present. Subsequently the system allows for notifications to be sent to those individuals who were denied explaining to them that their service was interrupted due to a medical emergency and thanking them for their cooperation, thus both servicing the individual who was having the heart attack, and proactively communicating with the other customers to reduce the impact of the service interruption.

In yet another aspect, the system can utilize the information collected by the client end devices (usage patterns, applications accessed, etc) to analyze, model, and predict customer satisfaction and value of each end point to each individual as well as value to the mobile operator. For example, the system can predict and the provide the end device value to the end user by looking at the frequency of use, usage characteristics, volume of data processed, variety of applications used and uploaded, number of customer care calls, etc. At the same time this same information can be processed to calculate the value of this individual customer to the mobile operators as compared to the revenue it brings vs. the support and service offering costs it requires to support customers behavior and usage patterns. Using this information, mobile operators can intelligently decide how to best service the customers and decide what the optimal device, service plan, etc, is for this customer. Unlike systems available on the market, this provides mobile operator with an external as well as internal view of their service offering.

Another significant churn factor is competitive offers. The telecom space in general is very competitive. Long distance carriers have been under siege for some time with extremely competitive offerings to outright free services. Mobile operators are facing the same scenario today. Lower price competitive offerings lure away customers creating, perhaps, one of the largest reasons for churn in the mobile telecom space. Once again current methods and practices involve tying the subscriber down through contractual commitments and penalties for breach.

In a further aspect of the invention, churn can be reduced or eliminated by providing firms the opportunity to match or beat competitive offerings to current customers by processing the inputs from these offerings that are available through early industry research or advertised offerings. Competitive offerings, if left not responded to by a carrier, can cause significant churn. Typically, when a carrier matches an offering, it rarely makes an effort to proactively reach out to the subscriber base in order to entice them to take it up.

In accordance herewith, an automatic notification through one of the messaging tools, with a “click and accept” response mechanism will enable the carriers to reach out to subscribers with their offer with an easy accept or reject mechanism. This is a cost-effective and pro-active method to reach out to the subscribers and entice them to join a new offer that secures the precious subscriber with their existing service provider.

The system can be used to directly reach customers using traditional tools such as email and SMS or issue prioritized tasks to sales or customer care reps to do a direct market campaign and call the subscribers.

In yet another aspect, inputs from existing OSS and subscriber usage analytics solutions can be used in accordance herewith to analyze network and devices performance data in order to attempt and reduce churn. The routing control plane of the network also contains a wealth of information that through an embodiment of this invention can be used to extract valuable information related to the subscriber behavior such as subscribers' location, contact list, technology used to connect to the network, billing scheme, services used, applications used etc.

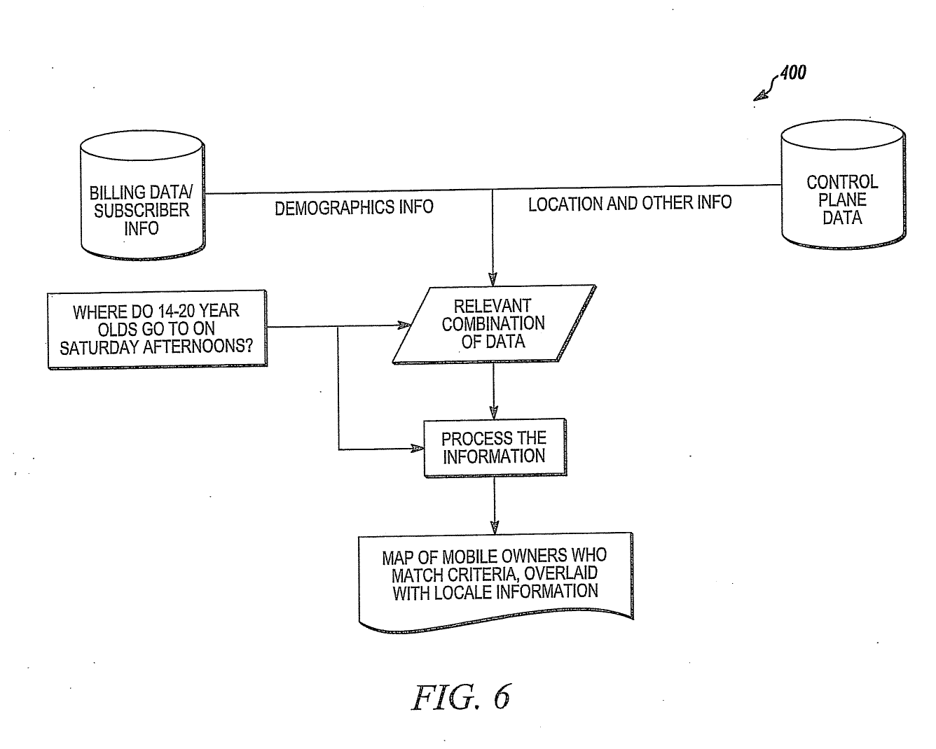

Relative to FIG. 6, embodiments of the invention can use data and information from multiple sources to further refine the information and create derivative information that could translate to an extremely valuable tool for operators to monetize their investment in the network. FIG. 6 illustrates exemplary processing 400 of such an implementation.

Several other key outputs from the system can include having a repository of such key customer information, network performance information as well as other service-affecting data enables system 40 to output more intelligent management and engineering reports than traditionally allowed by systems today. The system also generates information-rich analytical reports on periodic network performance and other aspects crucial for decision making.

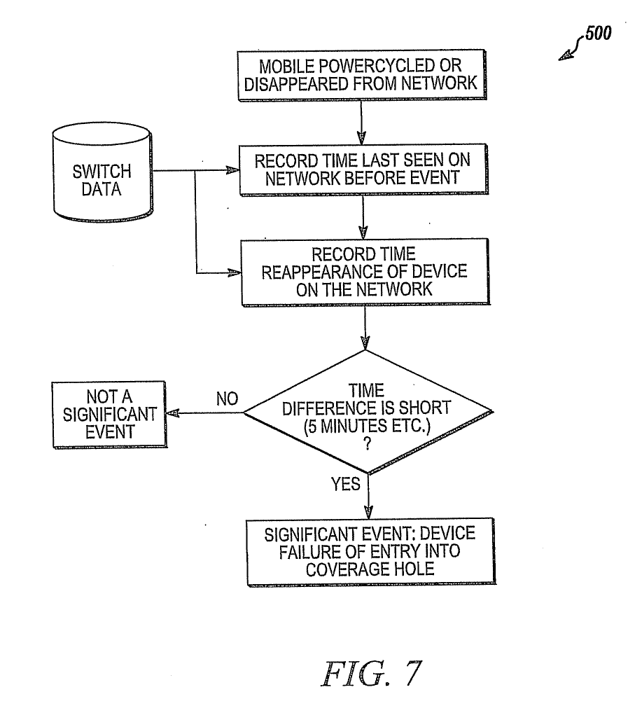

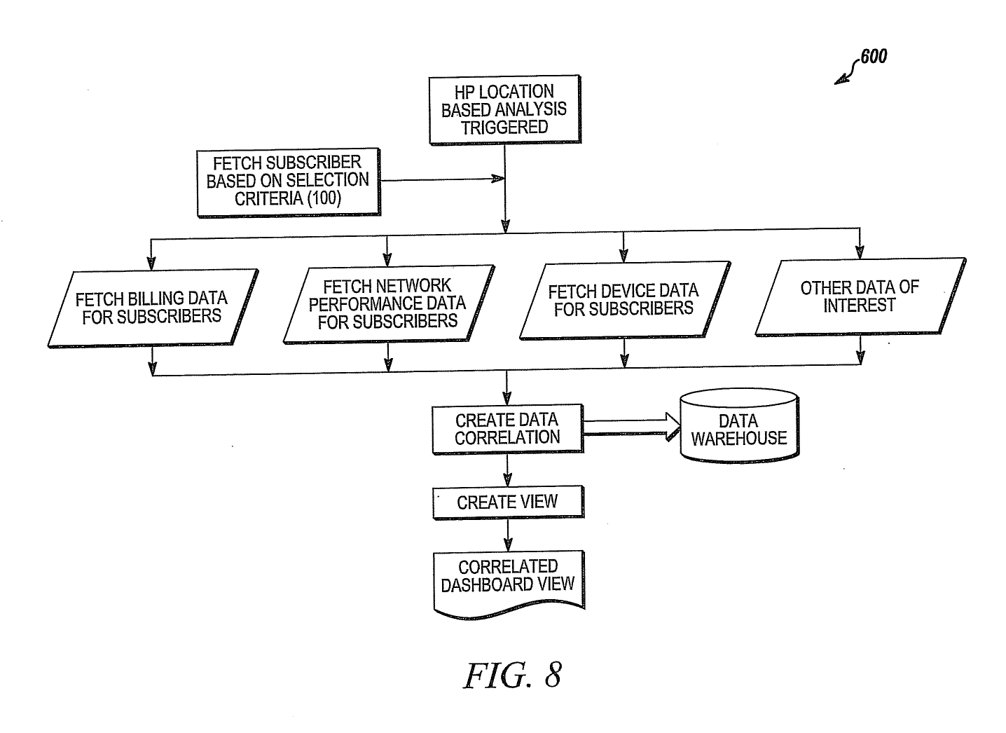

FIG. 7 illustrates exemplary processing 500 of system 40 to detect an abnormal absence of a subscriber device 14.

In another aspect of the invention the services associated with the system's capabilities can be offered using SaaS (Software as a Service) model. Using this model customers are provided with remote access to perform a variety of functions. For example and without limitation, operators can be enabled to use the system's pre-built churn management business rules. Users can be enabled to create their own churn management business rules and processes thereby enabling them to retain the value of business logic assets, ensure full traceability of decisions, be in specific regulatory compliance (if applicable) with fully auditable rules, and provide comprehensive decision support. In one embodiment this can be implemented with a drag and drop method within a graphical user interface. Operators can be enabled to simulate and test the functionality, results and impact of the proposed churn management business rules. Embodiments of the invention enable operators, or users to carry out various forms of statistical monitoring and analysis of the performance of established churn management business rules and their effectiveness in terms of churn management. In yet another aspect of the invention, operators can be enabled to create their own reports and define their presentation format and notification methodology.

The software services model provides additional benefits for a carrier. For example, a system wide performance repository can be provided. By creating such a repository, additional modeling can be done over larger data sets, and therefore creating more accurate methods, or, algorithms for forward looking event triggers.

The invention also incorporates a mechanism that offers High Precision Location Based Performance Analysis that enables mobile operators and other users of the system to view the health and status of the networks as well as the subscriber experience issues in a prioritized fashion. With networks getting increasingly complex, and various elements of the networks generating large quantities of data, the challenge of reviewing all of the data and prioritizing the issues that need to be addressed. The High Precision Location Based Performance Analysis offers the users of the system a “top down” view that correlates the network performance issues with other meaningful criteria, such as location of the issues and the Average Revenue Generated by users in that geographic location. The analysis, however, is not limited to the correlation examples provided above. FIG. 8 illustrates exemplary processing 600 of system 40 to provide a view of network issues correlated with location and ARPU (Average Revenue Per User). Similar analysis can also be implemented in determining a mechanism to be deployed by mobile operators for upgrading high revenue users to new handsets. A critical criteria in such changes is to ensure that the changes do not result in lower network usage, resulting in lower revenue for the operator. To that end, the invention introduces the concept of Average Revenue Per Device (ARPD), which when computed by system 40 will provide the operator with a “before and after” scenario that enables them to determine the financial viability of pushing the handset upgrade to high revenue subscribers. ARPD is calculated using the revenue generated by all subscribers of interest as computed by system 40 in example 100, and correlating it to the devices used by the same subscriber based yielded by computation 100.

In accordance with the invention, a mechanism is available that a user of the system could employ to input criteria to decide which devices or subscribers should be monitored by the system. It is often inefficient and taxing on the system, the processor as well as the data repository. Often times a carrier may employ the system to monitor a subset of the subscriber base based on a variety of criteria. The following exemplary criteria and user interfaces can be provided to create the monitoring selection criteria:

Mobile Identity Numbers

Geographic region (using a geo-fencing technique)

Cellular markets

Revenue Threshold

Profit Threshold

Subscriber count

Area code

Type of Device Used (smartphones, BlackBerry, data cards, etc.)

Type of applications accessed

Type of websites accessed

Type of failures or exceptions noticed

The invention does not limit the selection criteria to those listed above. The selection engine is capable of adding user defined criteria in the form of a Boolean query and use that to perform a selection. A combination of criteria as described above may also be used to select the monitoring criteria.

An embodiment of the invention will also ensure that subscribers that are being tagged and monitored by the solution will also be tagged as “VIP” subscribers in the customer care system. This ensures that any customer interfacing part of the organization that deals with the subscriber at any time, via phone or in person at a store know at all times that this is a VIP customer and needs to be dealt with at a different level of services than the generic customer. This ensures the fundamental principle of making sure that, all efforts will be made to ensure that currently valuable customer is not walking away from a customer care experience unhappy. It also ensures that junior employees can go solicit the help of a senior employee or a supervisor in order to make exceptions for such a customer.

An important aspect of the invention is the pro-active nature it adopts to ensure that the users of a product or service are getting the absolute best possible experience. It does so, by analyzing data from all possible sources available to the embodiment of the invention and then creating a causal relationship between the events in those data sources that may potentially create customer dissatisfaction. The causal relationship between data sources the corresponding events is then be used by the invention to:

(a) create a prediction model that pro-actively alerts the service provider regarding the eventuality of the customer being dissatisfied and offering a probability of the customer churning

(b) create an event-reaction paradigm: whereby for every event that triggers a customer dissatisfaction issue, reacts with the necessary steps to automatically adjust the necessary component in the network elements to counter-act the event. Such reactions vary from a simple notification, to automatic adjustments to available resources for the subscriber, to a key component in the network, such as triggering the network to bond channels to offer additional bandwidth.

Existing systems differ from the current invention fundamentally in the approach it takes to proactively address the issues. Current systems wait for a dissatisfied subscriber to call when an event occurs and then record that event in order for a manual intervention to address the issue after the fact. Recognizing that it is too late to address the issue after the fact, the current invention attempts to anticipate the event occurring for an operator selected group of subscribers. The invention, furthermore, implements a self-correcting mechanism to modify the existing network conditions to neutralize the offending event.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A communications apparatus comprising:
a communication system;
a correlated analysis system; and
a closed loop churn management system coupled to the communication system where the churn management system responds to inputs indicative of a least subscriber dissatisfaction to generate feedback signals to automatically adjust the communication system to minimize the subscriber dissatisfaction.

2. An apparatus as in claim 1 where the churn management system includes a programmable processor with pre-stored executable instructions to respond to inputs relating to one or more of, product type, product installation, subscriber usage characteristics, subscriber preferences, billing information and promotions.

3. An apparatus as in claim 2 which includes circuitry to produce at least customer promotional outputs and associated reports to promote selective savings to existing subscribers.

4. An apparatus as in claim 3 which includes additional circuitry to monitor subscriber usage patterns and to respond thereto to offer at least one variation on subscriber fee arrangements to thereby reduce subscriber charges.

5. An apparatus as in claim 1 where the churn management system includes circuitry to monitor subscriber usage patterns and to respond thereto to offer at least one variation on subscriber fee arrangements to thereby reduce subscriber charges.

6. An apparatus as in claim 1 where the churn management system includes circuitry to enable a user to select of a plurality of criteria to be processed in combination with selected additional information to establish feedback signals to adjust the telecommunication system in accordance therewith.

7. An apparatus as in claim 6 where the adjustment is carried out automatically and the churn management system also automatically provides feedback as to the system adjustment to at least one subscriber.

8. An apparatus as in claim 6 which includes circuitry to analyze communication system performance information.

9. An apparatus as in claim 8 which includes initiating one or more of exception reports relative to communication system operations, messages to subscribers, or the feedback signals to automatically adjust the communication system to minimize the subscriber dissatisfaction.

10. An apparatus as in claim 1 which includes circuitry responsive to subscriber usage to direct a subscriber from a current pricing plan to a different pricing plan.

11. An apparatus as in claim 8 which includes circuitry responsive to subscriber usage to direct a subscriber from a current pricing plan to a different pricing plan.

12. An apparatus as in claim 1 which includes circuitry to process demographic information and to produce a report in connection therewith.

13. An apparatus as in claim 1 which includes circuitry to detect an absent subscriber device.

14. A method of operating a communications system comprising:
coupling a churn reduction system to the communications system and responding to inputs indicative of a least subscriber dissatisfaction and generating feedback signals to automatically adjust the communication system to minimize the subscriber dissatisfaction.

15. A method as in claim 14 which includes directing the subscriber from a current pricing plan to a different pricing plan.

16. A method as in claim 14 which includes providing feedback to the communications system to adjust at least one parameter thereof to improve subscriber service.

17. An apparatus as in claim 1 which includes circuitry to correlate information from multiple sources to create a high precision location based performance analysis system that offers a prioritized view of subscriber experienced issues relative to other selected criteria.

18. An apparatus as in 1 which includes circuitry to determine selected information, based on predetermined criteria including average revenue per device.

19. A method as in claim 14 which includes correlating information from multiple sources to create a high precision location based performance analysis system that provides a prioritized view of subscriber experienced issues with respect to selected significant criteria.
